(19) United States
(12) Patent Application Publication
(10) Pub. No.: US 2012/0276290 A1
(43) Pub. Date: Nov. 1, 2012

(54) SILICA NANOPARTICLES WITH ROUGH SURFACE

(75) Inventors: Xiaojun Julia Zhao, Grand Forks, ND (US); Shuping Xu, Grand Forks, ND (US)

(73) Assignee: UNIVERSITY OF NORTH DAKOTA, Grand Forks, ND (US)

(21) Appl. No.: 13/457,719

(22) Filed: Apr. 27, 2012

Related U.S. Application Data
(60) Provisional application No. 61/480,161, filed on Apr. 28, 2011.

(51) Int. Cl. C01B 33/12; B05D 7/00; B82Y 40/00

(52) U.S. Cl. 427/212; 423/335; 977/775

(57) ABSTRACT

A method for preparing nanoparticles includes preparing a mixture containing an organic solvent, surfactant and water; adding a first quantity of a first silica precursor and ammonia to the mixture; adding a second quantity of the first silica precursor and a second silica precursor to the mixture; adding acetone to the mixture; removing silica nanoparticles from the mixture; and drying the silica nanoparticles.

### STATEMENT OF GOVERNMENT INTEREST

This invention was made with government support under Grant Nos. CHE-0616878, CHE-0911472, and EPS-0814442 awarded by the National Science Foundation. The government has certain rights in the invention.

### BACKGROUND

Silica nanomaterials have a broad range of applications due to several unique features: little absorption in the UV-Vis and near infrared region, dielectric electrons, and low toxicity. Halas, N., J. ACS Nano 2008, 2, 179; Wang, L. et al., Anal. Chem. A-Pages 2006, 78, 646; Jin, Y. et al., Chem. Res. Toxicol. 2007, 20, 1126. These characteristic enable silica nanoparticles to be widely utilized as a solid-supporting or entrapping matrix. Xu, S. et al., Langmuir 2008, 24, 7492; Jin, Y. et al., Coordin. Chem. Rev. 2009, 253, 2998; Santra, S. et al., Adv. Mater. 2005, 17, 2165; Santra, S. et al., J. Biomed. Opt. 2001, 6, 1; Santra, S. et al., Anal. Chem. 2001, 73, 4988.

Compared with other inherently functional nanomaterials (e.g., semiconductor quantum dots, carbon nanotubes, plasmonic nanoparticles, and magnetic nanoparticles), the merits of silica nanoparticles can be totally embodied in their applications only when combined with other materials with remarkable optical, magnetic, electrical, catalytic, or biological activities. Jin, Y. et al., Chem. Mater. 2008, 20, 4411; Santra, S. et al., Anal. Chem., supra.; Zhao, X. et al., J. Am. Chem. Soc. 2003, 125, 11474; He, X. X. et al., J. Am. Chem. Soc. 2003, 125, 7168. Such functional materials can be either encapsulated inside the silica matrix or linked to the surface of the silica nanoparticles. The latter pathway requires functional sites on the silica nanoparticle surface to link the functional molecules. To this end, in order to achieve a broad range and a high efficiency of applications, a large number of surface functional sites are needed.

There are two primary methods for the preparation of silica nanoparticles: the Stöber sol-gel method (Stöber, W. et al., J. Colloid Interface Sci. 1968, 26, 62) and the water in oil reverse microemulsion method (Bagwe, R. P. et al., Langmuir 2004, 20, 8336). Both methods are based on the hydrolyzation and condensation of tetraethyl orthosilicate (TEOS) under either acidic or basic conditions. Using these two methods, most silica nanoparticles are spherical (there are a few ellipsoids) with a smooth surface covered by hydroxyl groups. The surface hydroxyl group is somewhat limited in its ability to cope with the requirements of various linking reactions. Thus, further surface functionalization is needed to provide a more diverse range of chemical groups to make the silica nanoparticles accessible to various surface linking strategies. Meanwhile, the smooth surface provides limited surface area as the size of nanoparticles is fixed. Given the same dimension, it can be appreciated that one way to increase the surface area is to provide the nanoparticles with a rough surface.

Morphological changes can directly alter the properties of nanomaterials, including physical constants (density, surface area, porosity, etc.), optical properties (George T. F. et al., J. Phys. Chem. 1987, 91, 3779), and wetting behavior (Beysens, D. A. et al., Langmuir 2007, 23, 6486; Marmur, A., Langmuir 2003, 19, 8343). Thus, in addition to the increased surface area, the roughened surface will provide the functional materials with different binding capacity because the immobilization of many functional molecules are based on the selective adsorption interaction (You, Y-Z. et al., Chem. Mater. 2008, 20, 3354; Roy, I. et al., PNAS 2005, 102, 279; Yang, J. et al., Langmuir 2008, 24, 3417) such as catalysts, enzymes, antibodies, and drugs. It has been reported that the adsorption kinetics on a rough surface are different than those on a smooth surface because of the different diffusion rate through a stagnant layer of solvent near the surface. Saffarian, H. M. et al., J. Phys. Chem. B 2002, 106, 7042. The slow chemical reaction of the encapsulated functional molecules with the outside targets has been reported for the silica-based nanoparticles. Liang, S. et al., J. Phys. Chem. C, 2009, 113, 19046. A rough surface may speed up this reaction through easy surface adsorption of targets. Thus, silica nanoparticles with a rough surface are needed.

So far, several physical methods have been developed to prepare the rough or patterned surfaces, such as nanosphere lithography (Haynes, C. L. et al., Nano Lett. 2003, 3, 939); electron-beam lithography (Felidj, N. et al., Appl. Phys. Lett. 2003, 82, 3095); and optical lithography (Black, C. T., ACS Nano, 2007, 1, 147). These methods are usually carried out on the flat substrates. It is difficult to handle these techniques on a curved surface, even the architecture on a single spherical nanoparticle. Thus, the current physical methods are not applicable for making silica nanoparticles with a rough surface.

A chemistry approach might be considered. In a chemical reaction in a solution, all dimensions of nanoparticle surface are accessible for manipulation of its roughness. Meanwhile, considering the facile treatment process and relatively low cost of the equipment employed, a chemical approach is preferred. However, even using a chemistry method, the manipulation of the roughness of the surface on each spherical nanoparticle is a great challenge.

Recently, it was found that several organotriethoxysilane precursors could lead to the mesoporous silica particles when co-condensing with TEOS in a micelle-forming surfactant system. Kumar R. et al., ACS Nano 2008, 2, 449. The silane precursors have been used for modification and functionalization of silica nanoparticles through postcoating of the silica nanoparticles. The silane precursors have similar structures to TEOS and share the same mechanism of hydrolization and condensation. Differing from TEOS, the silane precursors provide multi-functional groups, for instance, mercapto, carboxyl, amino, and phosphonate, which increase the flexibility of the surface reactions and extend the applied field of the silica nanoparticles. You, supra.; Roy, supra.

Different silane precursors co-condensing with TEOS not only alter the distribution of the functional groups on the silica nanoparticle surface, but also change the morphology of the silica matrix. However, the effect of the silane precursors on the morphology of produced silica nanoparticles is rarely discussed in literature.

### SUMMARY

A method for preparing nanoparticles includes preparing a mixture containing an organic solvent, surfactant and water; adding a first quantity of a first silica precursor and ammonia to the mixture; adding a second quantity of the first silica precursor and a second silica precursor to the mixture; adding acetone to the mixture; removing silica nanoparticles from the mixture; and drying the silica nanoparticles.

A method for producing nanoparticles having a silica shell with a rough surface includes preparing a mixture containing nanoparticle cores, forming a shell around the nanoparticle cores by adding a first silica precursor and a second silica precursor to the mixture, removing nanoparticles having a silica shell from the mixture and drying the nanoparticles so that the silica shell has a rough surface.

### BRIEF DESCRIPTION OF THE DRAWINGS

FIG. 1 is a representative illustration showing silica nanoparticles produced according to one embodiment of the present invention.

FIGS. 1A, 1B and 1C are transmission electron microscopy (TEM) scans showing the silica nanoparticles produced according to one embodiment of the present invention.

FIG. 2 illustrates a series of TEM scans showing different silica nanoparticles produced according to the present invention.

FIG. 3 is a graphical representation of an elemental analysis of silica nanoparticles produced according to the present invention.

FIG. 4 illustrates a series of TEM scans showing silica nanoparticles produced according to one embodiment of the present invention.

FIG. 5 shows representative illustrations of compounds and interactions achieved according to one embodiment of the present invention.

FIG. 6 is a graphical representation of a titration curve observed during the preparation of silica nanoparticles.

FIG. 7A is an image showing the silica-NIR dye nanocomplex suspended solutions produced using varying amounts of 3-aminopropyltriethoxysilane (APTS).

FIG. 7B illustrates the UV-Vis spectra of silica-NIR 797 isothiocyanate nanocomplexes produced using varying amounts of APTS.

FIG. 7C is the calibration curve of the integral area of the absorption spectra versus the concentration of NIR dye.

FIG. 7D is a comparison of the adsorption amounts of NIR dye on different silica nanoparticles.

FIG. 8 illustrates a TEM scan of silica-Au satellitic nanocomplexes.

### DETAILED DESCRIPTION

This invention concerns the production of nanoparticles with a loose network structure as well as varying degrees of surface roughness. Smooth-surface nanoparticles are well known in the art. A roughened surface provides more surface area, which is desirable for many applications. The loose network structure of these nanoparticles can facilitate, for example, rapid drug release when used for drug delivery.

A chemical method is disclosed to produce and control the surface roughness of silica nanoparticles and to increase the type of surface functional groups by using silane precursors. The silica nanoparticles are so produced and controlled by including certain amounts of a precursor, 3-aminopropyltriethoxysilane (APTS), in the hydrolysis of tetraethyl orthosilicate (TEOS).

Roughened silica nanoparticles can be synthesized using conventional reverse microemulsion techniques (Bagwe, supra.) modified as follows, and with reference to the various drawings. It will be appreciated that the quantities, amounts, volumes and values set forth herein are representative and depict an exemplary embodiment but can vary within the spirit and scope of the invention.

In an exemplary embodiment, 7.50 mL of cyclohexane (HPLC-grade) is used as the organic solvent. A 1.77 mL aliquot of Triton™ X-100 (UNION CARBIDE CORP., Midland, Mich.) surfactant and 1.80 mL of 1-hexanol (99+%) co-surfactant is added into the cyclohexane under stirring. A 480 μL aliquot of water (Milli-Q, 18.6 S2 cm⁻¹) is added to the mixture. The water can be totally dispersed into the cyclohexane since droplets are formed in the presence of the surfactants. 50 μL of tetraethyl orthosilicate (TEOS, 98%) is added, followed by 60 μL of 29% ammonia (29.5%, ACS) to catalyze the hydrolyzation of TEOS to form compact silica cores. The resulting mixture is preferably stirred for approximately 24 hours.

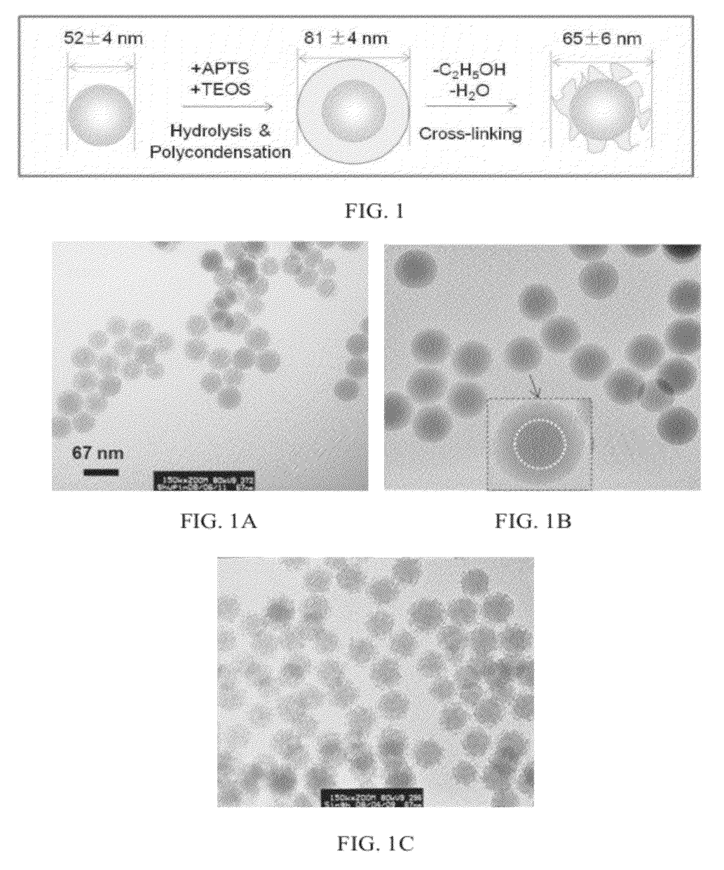

As is known in the art, a water-in-oil reverse microemulsion is an isotropic and thermodynamically stable single-phase solution. Water droplets are formed in the bulk organic solvent and serve as nanoreactors for the synthesis of nanoparticles from various silane precursors. TEOS is a typical water-soluble precursor for the synthesis of silica nanoparticles. Upon the polymerization of TEOS, a silica core is formed in the water droplet. As the polymerization progresses, the silica core grows and, finally, a stable silica nanoparticle is produced in the water droplet. Spherical silica nanoparticles are produced having an average diameter of 52±4 nm as shown in FIGS. 1 and 1A.

An additional 50 μL of TEOS and a predetermined amount of 3-aminopropyltriethoxysilane (APTS, 95%) is then added as a post-coating treatment to modify the surface of the silica nanoparticles. As will be discussed in greater detail below, APTS can be added in any amount, preferably between 0-150 μL, depending on the desired level of roughening. The TEOS and APTS are allowed to hydrolyze while the mixture is stirred, preferably for approximately another 24 hours. In this process, hydrolyzed TEOS and APTS are deposited onto the silica cores and form a layer of silica shell on the silica cores. This shell is expected to be less dense than the core, and thus should be clearly identifiable from the enlarged nanoparticle on a TEM image as shown in FIGS. 1 and 1B. As will be appreciated by those skilled in the art, lighter grays on the TEM scan indicate that the density of the shell is lower than that of the core.

The microemulsion is broken by adding approximately 20 mL of acetone (ACS grade, Aldrich). The silica particles are removed from the mixture by centrifugation and washed, preferably three times with copious amounts of ethanol. The white silica precipitates are then air dried at least approximately one day's time (24 hours), preferably over at least two days (48 hours). This drying treatment is crucial to the roughening process, because the silica shell will change in density during this process and lead to different morphologies that vary with the amount of APTS added.

Upon drying, the silica nanoparticles shrink, the silica shell is converted into a loose structure, and the surface becomes roughened. These changes are clearly detectable via TEM as shown in FIG. 1C. As observed (referring back to FIGS. 1, 1B and 1C), the diameter of the silica nanoparticles shrink from 81±4 nm to 65±6 nm. The approximate change of the surface area during roughening can be calculated using the Brunauer-Emmet-Teller (BET) technique. Theoretically, the smooth surface area of similarly sized silica nanoparticles is about 47 m²/g. The observed significant increase of 72% surface area is attributable to the surface of silica nanoparticle becoming rough.

The dried particles, which may be in hardened, block form, can be ground into fine powder (e.g., via an agate mortar) before usage. Nanoparticle solutions are prepared by suspending the particulate powder in water and optionally sonicating the mixture for at least one hour. Stock nanoparticle solutions are preferably prepared at 1.0 mg/mL.

The schematic diagram shown in FIG. 1 and the TEM scans in FIGS. 1A, 1B and 1C summarize the changes of morphology and size in the process of the nanoparticle formation. The morphology of the particles after drying coincides with the “compact core-loose shell” structure. The drying treatment is the key process for the formation of such rough silica nanoparticles.

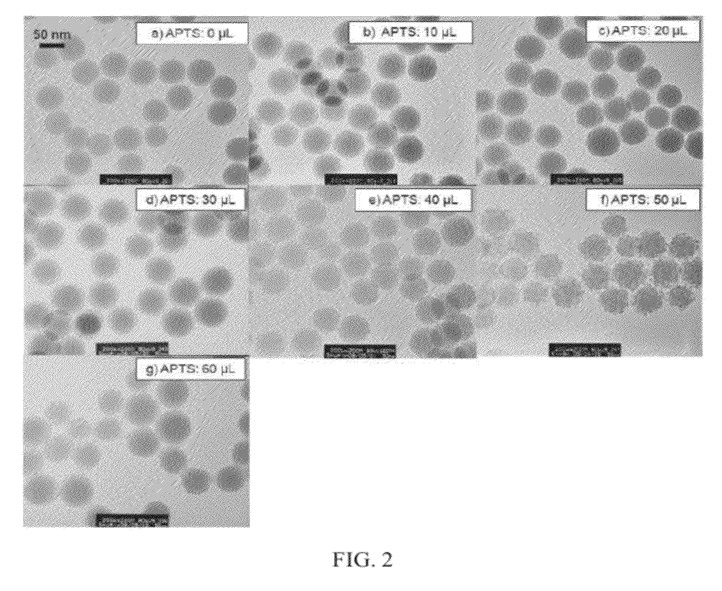

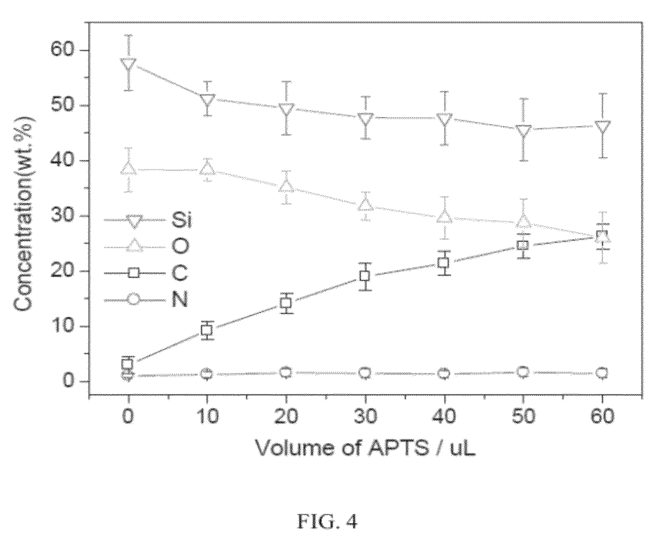

As illustrated in FIG. 2, there is a direct correlation between the concentration of APTS and the formation of a rough surface in the synthesis of the silica shell, particularly when the amount of TEOS added with the APTS (the second addition of TEOS) remains constant (50 μL). Initially, without APTS, the silica nanoparticles possess a smooth surface (FIG. 2, panel a). When 10 μL of APTS is added, the surface of the silica nanoparticles changes to an insignificant rough (FIG. 2, panel b). When the amount of APTS is increased from 10 μL to 20 μL, 30 μL, and 40 μL, respectively, the roughness of the nanoparticle surface gradually increases (FIG. 2, panels c, d, and e). An even rougher surface is obtained when the amount of APTS is increased to 50 μL, which is equal to the amount of TEOS added with the APTS (FIG. 2, panel f). These results clearly demonstrate that the APTS causes a rough surface and the extent of the roughness increases with the amount of APTS. Thus, in one embodiment of the present invention, the amount of APTS added and the second quantity of TEOS added forms a ratio between 1:50 and 1:1.

When the amount of APTS is increased to 60 μL, the reverse microemulsion changes from a clear emulsion into a nontransparent mixture, and a great deal of white silica gel is deposited on the walls of the reaction bottle. The resultant nanoparticles were not of uniform size, and surface roughness significantly disappeared (FIG. 2, panel g). APTS amounts from 70 μL to 150 μL (not shown) yield similar results, with increasing silica gel deposits. The presence of silica gel deposits indicates that the reverse microemulsion micelles have been destroyed. These micelles play an important role in the polymerization of silica precursors. The formation of the silica shell is limited within the micelle. When the micelles are destroyed, the process of the silica shell growth is out of control. The majority of APTS is instead converted to silica gel. Thus, to obtain the roughest surface of the silica shell, the selection of optimal APTS amounts is essential.

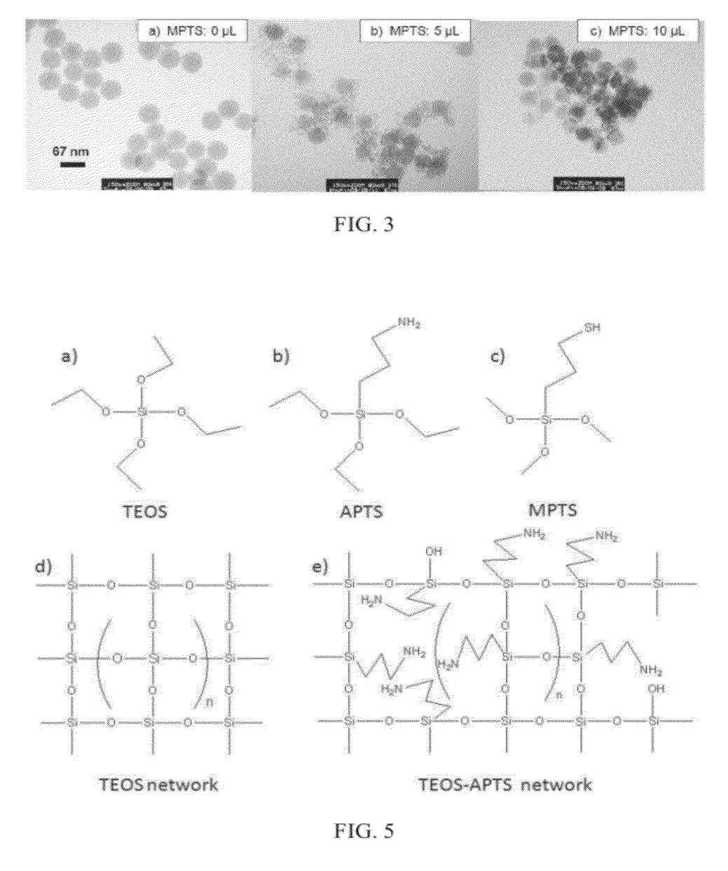

Turning to FIG. 3, an alternative silica precursor, 3-mercaptopropyltrimethoxysilane (MPTS), can be used to synthesize the silica shell. The structure of MPTS is similar to that of APTS, except that the terminal group is a mercapto group and not an amino group and three oxymethyl groups replace the three oxyethyl groups of APTS. Compared to the smooth surface without MPTS (FIG. 3, panel a), a small amount of MPTS (5 μL) resulted in a roughened surface of the silica nanoparticles (FIG. 3, panel b). But the roughness was not as uniform as that from the APTS (see FIG. 2, panel f). As the amount of MPTS increases, the roughness of the silica nanoparticles was reduced and the particles adhered to each other (FIG. 3, panel c). MPTS is therefore a less desirable silica precursor for making roughened silica nanoparticles. But the similar effect from both APTS and MPTS indicate that the one terminal end on the silane precursors plays a role in making the roughened surface.

Characteristics of Resulting Silica Nanoparticles

The size and morphology of the resulting silica nanoparticles is capable of being characterized by transmission electron microscopy (TEM). By way of example, a Hitachi 7500 TEM operating at 80 kV can be used to analyze silica nanoparticles. The size of the silica particles can be obtained by measuring over 200 particles on the TEM images.

The specific surface area of the particles can be measured by third parties such as Porous Materials, Inc. (Ithaca, N.Y., USA). About 100 mg of particle powders can be used for each such measurement, at a testing temperature of about −195.76° C., and utilizing nitrogen as the adsorbent.

The components of the resultant nanoparticles can be analyzed using an energy-dispersive X-ray spectroscope (EDS) that is attached to a scanning electron microscope. The observed weight percentages of Si, O, C and N in different nanoparticles are shown in FIG. 4. In the APTS-free nanoparticles, the percentages of Si, O, C and N were 57.7%, 38.3%, 3.0% and 1.0% by weight, respectively. As the APTS amount increased, the percentages of Si and O decreased, while the percentage of C increased remarkably. Corresponding to APTS amounts of 10 μL, 20 μL, 30 μL, 40 μL, and 50 μL, the carbon percentage by weight was 9.2%, 14.1%, 19.0%, 21.4% and 24.6%, respectively. The percentage of the nitrogen was suspect because its concentration remained in the instrumental error range. There were two possible sources of the increased carbon: 1) the propyl group (—C₃H₆—) on the APTS molecule; and 2) potentially unhydrolyzed oxyethyl groups (—OC₂H₅) from TEOS or APTS. In the postcoating process, only the amount of APTS was adjusted and the TEOS amount was kept at 50 μL for all the trials, meaning that if any unhydrolyzed oxyethyl groups (−OC₂H₅) were contributed from the TEOS, it should have remained consistent. The incremental changes on the carbon weight were only from the ethylic and oxyethyl groups of additional amounts of APTS. Thus, the EDS results demonstrated that a significant amount of APTS successfully participated in the formation of silica shell, and the amount of final deposited APTS can be directly altered by the amount of APTS added in the synthesis process. The elemental analysis supports that the APTS is indeed the key factor for forming the rough surface and the roughness level is adjustable by varying the APTS amount.

The relative concentration of amino groups on the nanoparticle surface can be measured using titration. First, 1 mL of NaOH (0.0994±0.0003 mol/L) is added to 20 mL of an aqueous solution containing 5.0 mg of nanoparticles. This strong base will convert the —NH₃⁺ to —NH₂. Under stirring, several microliters of HCl are added to the solution. The pH values can be recorded and the titration curve plotted with the amount of HCl (0.104±0.001 M) added. The HCl can be standardized using dried Na₂CO₃.

Turning now to FIG. 5, and based on the above results, a mechanism is disclosed for the formation of the rough surface of the silica. The molecular structures of TEOS, APTS, and MPTS are shown in panels a, b and c of FIG. 5, respectively. The TEOS molecule (FIG. 5, panel a) and the APTS molecule (FIG. 5, panel b) have a similar chemical structure with their branched oxyethyl groups. The difference is that TEOS has four oxyethyl groups while APTS has three along with an aminopropyl group. The oxyethyl groups can be hydrolyzed in the reverse microemulsion under the catalysis of ammonia. The formed hydroxyl groups can replace the oxyethyl groups and be polycondensed to a long chain containing a number of (—O—Si—O—) units. In the drying process, these chains cross-link and form an (—O—Si—O—) network by losing one molecule of C₂H₅OH or H₂O (FIG. 5, panel d). This reaction can be accelerated by heating. Ek, S. et al., Langmuir 2003, 19, 10601.

The difference in the molecular structure of APTS and TEOS resulted in a different network structure of the dried silica shell (FIG. 5, panel e). The terminal amino group could not participate in the polymerization as did the other three oxyethyl groups. As a result, the existence of the terminal amino group of APTS provided its network with more defective sites compared with the TEOS network. With the departure of C₂H₅OH and H₂O, the unperfected network collapses and sinks. The produced nanoparticles were scaled down to smaller sizes and became loose skeletons. Thus, the formation of the loose layer and the rough surface derived from the defects of APTS molecules. As shown in FIG. 5, panel c, MPTS has a similar terminal group on its molecular structure, and thus produced the roughened silica nanoparticles as well.

As described above, based on the BET measurement, the rough surface provides a larger surface area than the smooth one. Usually, the purpose of having a large surface area is to provide more reactive groups on the nanoparticles. One can determine the available amino groups on the rough surface of silica nanoparticles. The nanoparticle with a particularly rough surface, made with 50 μL of APTS, is a suitable candidate.

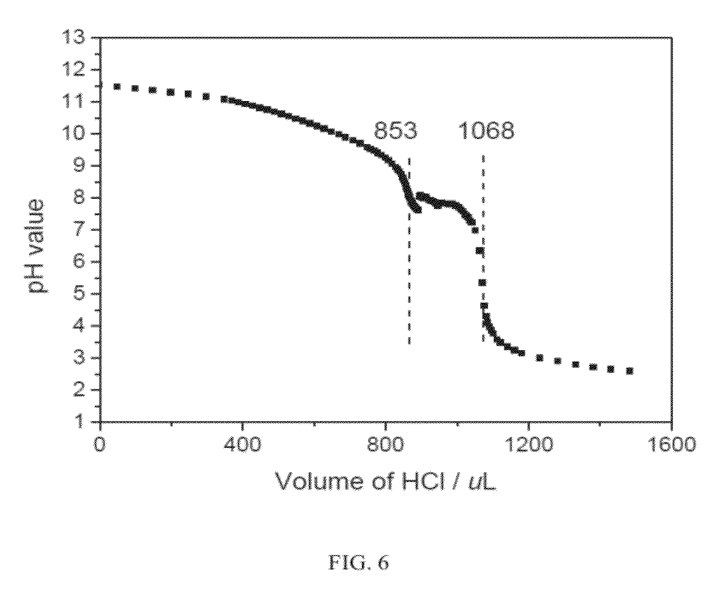

Traditional acid-base titration can be employed for the determination of the amino groups on the nanoparticles. Available amino groups act as a weak base. The pH value of a 0.275 mg/mL nanoparticle solution was 9.30. To accurately conduct the titration, the pH of this nanoparticle solution was adjusted to a more basic value of 11.50 using 1.0 mL of 99.473 μmol/L NaOH. At such a condition, the amino groups exist in the form of —NH₂ only. In this case, the solution is composed of two bases: a strong base (excess NaOH) and a weak base (—NH₂ groups on the particles). FIG. 6 illustrates the titration curve of the basic solution by HCl. In the beginning, the pH value decreases slowly in the range of 11.50-9.05 where the free OH⁻ from NaOH is neutralized by the HCl. Then, the pH value reduces much more quickly in the range of 9.05-7.88 followed by a plateau. Then, a small amount of HCl solution (only 2 μL) makes the pH value suddenly go down. The equilibrium process takes about half an hour because the naturalization of the weak base of amino group with the H⁺ (—NH₂+H⁺→—NH₃⁺) is quite slow. After all the —NH₂ is converted to —NH₃⁺, the pH value strongly depends on the amount of excess HCl, accounting for a second sharp decrease from pH 7.20 to pH 3.50. According to the consumption of HCl (about 215 μL) by —NH₂, the amount of amino groups present is 4.05 μmol/mg of particles. Based on the amount of APTS added to the reverse microemulsion, it will be appreciated that over 84.0% of APTS is hydrolyzed and forms the network structure of the silica shell.

The reactivity of the amino groups on the nanoparticles is characterized by measuring its dissociation constant. The equilibrium of amino groups in water is as shown below:

—NH₂+H₂O [symbol] —NH₃⁺+OH⁻

At equilibrium, the pH of the nanoparticle solution is 9.30. As shown in FIG. 6, the amounts of —NH₃⁺ and —NH₂ on the silica nanoparticles can be determined. The amount of —NH₃⁺ is calculated based on the amount of NaOH used for converting —NH₃⁺ to —NH₂. At the beginning, 99.4 μmol of NaOH is added. During the titration, a total of 88.7 μmol HCl is used to neutralize OH⁻. The difference of 10.7 μmol NaOH is used to neutralize —NH₃⁺ in the nanoparticle aqueous solution. Thus, the concentration of —NH₃⁺ is 0.535 mM and the concentration of —NH₂ is 0.5775 mM. The dissociation constant of the amino groups on the silica particles can be expressed in the form of pKa. Thus, pKa=pH+log [—NH₃⁺]/[—NH₂]=9.30+log [0.929]=9.27.

The architecture at the nanoscale level has been a challenge in the field of nanoscience and nanotechnology. According to the present invention, a universal method has been developed to construct a rough silica layer on spherical silica nanoparticles. Different degrees of surface roughness can be successfully controlled by adjusting the amount of functional silane precursors. The coverage of amino groups on the silica particle can be determined using acid-base titration method. Results showed that 4.05 μmol amino groups/mg particle were obtained, with 48% of these presented as —NH₃⁺ and 52% presented as —NH₂. These silica nanoparticles can be an excellent solid-supporting carrier for containing NIR dye molecules and for the physical absorption of small gold nanoparticles. These rough surface silica nanoparticles could be a promising nano carrier for entrapping not only small organic molecules but also functional nanoparticles.

The resulting silica nanoparticles can be manipulated in a number of ways, including as described in the following, non-limiting examples:

### Example 1

Silica nanoparticles have a wide variety of applications following effective surface functionalization. The produced rough surface nanoparticles of the present invention provide silica nanoparticles having a large number of surface amino groups. The amino groups are highly valuable functional groups that can react with some important chemicals for applications of the silica nanoparticles. For example, the amino groups can react with isothiocyanate groups under mildly alkaline conditions. The amino groups can also react with α-carboxyl groups to form amide bonds.

To demonstrate the potential applications of the amino-modified silica nanoparticles, a silica nanocomplex can be prepared with NIR 797 isothiocyanate, a near-infrared (NIR) fluorescent molecule. The nanocomplex can be used as NIR labels for detection of biological samples. NIR 797 isothiocyanate can be chemically adsorbed onto the silica nanoparticles by reacting with amino groups on the particle surface. NIR 797 isothiocyanate reacts with amino groups on the nanoparticles by forming covalent bonds under mild alkaline conditions (pH ˜8.0).

In an exemplary embodiment, a 10 μL aliquot of 10.0 mg/mL NIR 797 isothiocyanate in DMSO was added to 1.0 mL of a 1.0 mg/mL aqueous silica nanoparticle solution prepared as described above. The solutions were kept at 4° C. overnight while the silica particles turned dark green in color. The silica-NIR dye nanocomplexes were removed from solution by centrifugation and washed three times with water. Then, this nanocomplex powder was suspended in water forming a 1.0 mg/mL stock solution.

The UV-Vis spectra of these nanoparticles were obtained conventionally, using a Shimadzu-4500 UV-Vis spectrophotometer. The silica-NIR 797 isothiocyanate nanocomplex solution was kept sonicating until transferred into a 1-cm quartz cuvette for testing. The stock particle solution was diluted three times before the measurement. The integral area of the absorption peak of NIR 797 isothiocyanate was used to compare the adsorption ability of different silica particles. Origin 6.0 software was used for calculation of the integral areas of the UV-Visible spectra.

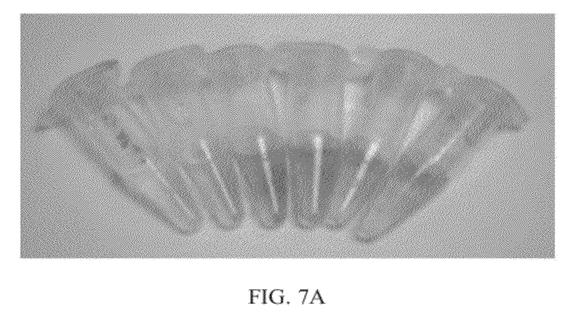

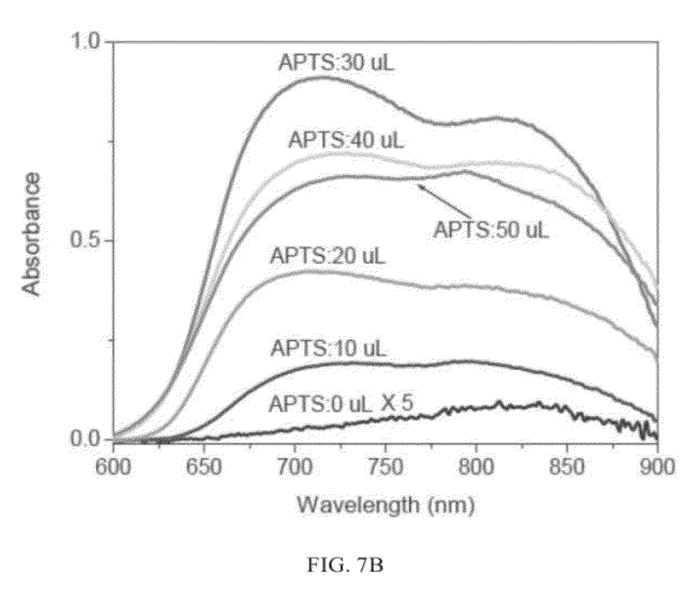

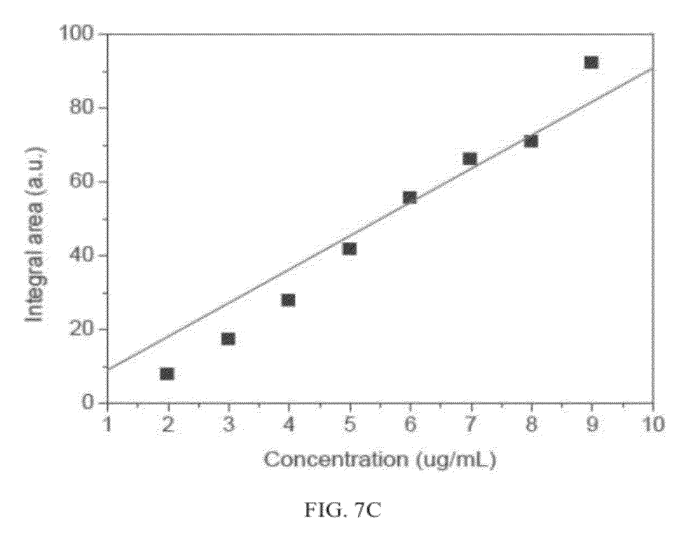

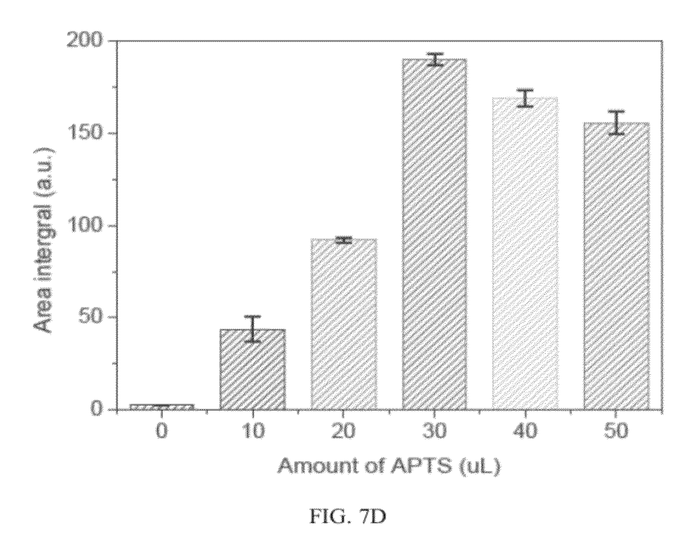

After linking with NIR 797 isothiocyanate, the color of the silica particles changed to green (shown as darker solutions in FIG. 7A). UV-Vis spectra of the NIR dye linked silica nanoparticles are depicted in FIG. 7B. NIR 797 isothiocyanate has two typical absorption bands at ˜710 nm and ˜820 nm. A plot of the concentration vs. integral area of NIR 797 isothiocyanate as a calibration curve is illustrated in FIG. 7C. The calibration equation was Y=8.79151 (±0.06642)X, with R=0.9994 (n=8). The integral area indicates the amount of the NIR dye. FIG. 7D shows the integral area of the absorption spectra corresponding to FIG. 7B, reflecting the adsorption ability of silica particles with different roughness. The 30 μL APTS silica particles presented the strongest adsorption ability (the integral area was 190.2). According to the calibration curve, the concentration of dye in the three times diluted nanocomplex solution was 21.64 μg/mL. Thus, there were 64.92 μg (0.074 μmol) of NIR dye/mg of silica particles. This result was 76 times of higher than that of the silica particles with a smooth surface.

The amount of NIR dye on the 40 μL and 50 μL APTS particles decreased slightly (57.68 μg and 53.14 μg, or 0.065 μmol and 0.060 μmol, respectively), but they still possessed strong adsorption ability for NIR dye.

### Example 2

A silica-gold satellitic nanocomplex having Au-nanoparticles of 4±1 nm in diameter was synthesized utilizing means known in the art. The silica nanoparticles were added to the gold nanoparticle solution and reacted for 5 minutes. Excess Au-nanoparticles were removed by centrifugation at a relative centrifugal force of 3214 g and removal of the supernatant. Silica-Au satellitic nanocomplexes were harvested from the precipitate.

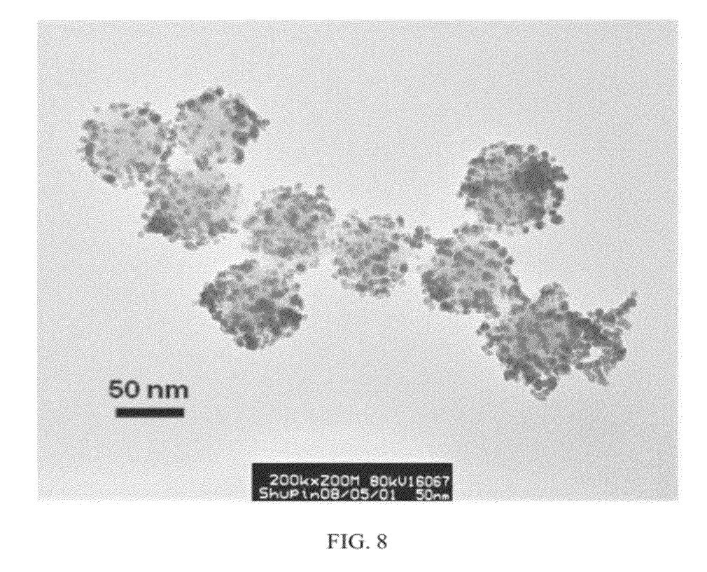

Gold nanoparticles were quickly captured by the silica particles. As shown in FIG. 8, the silica-Au satellitic nanocomplexes exhibited good dispersion on the TEM scan. They also present good stability when compared to gold colloids. The nanocomplexes can be easily resuspended in the aqueous solution even after they were treated by centrifugation several times. This stability is helpful for applications with gold nanoparticles in various fields.

Whereas, the present invention has been described in relation to the drawings attached hereto and through the examples set forth herein, it should be understood that other and further modifications, apart from those shown or suggested herein, may be made within the spirit and scope of this invention.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A method for preparing nanoparticles, the method comprising:
preparing a mixture comprising an organic solvent, surfactant and water;
adding a first quantity of a first silica precursor and ammonia to the mixture;
adding a second quantity of the first silica precursor and a second silica precursor to the mixture;
adding acetone to the mixture;
removing silica nanoparticles from the mixture; and
drying the silica nanoparticles.

2. The process of claim 1, wherein the organic solvent is cyclohexane.

3. The process of claim 1, wherein the surfactant comprises Triton™ X-100.

4. The process of claim 3, wherein the surfactant further comprises 1-hexanol.

5. The process of claim 1, wherein the first silica precursor is TEOS.

6. The process of claim 5, wherein the second quantity of TEOS is approximately the same as the first quantity.

7. The process of claim 1, wherein the second silica precursor is APTS.

8. The process of claim 7, wherein a ratio of the APTS added and the second quantity of TEOS is between 1:50 and 1:1.

9. The process of claim 1, wherein the second silica precursor is MPTS.

10. The process of claim 9, wherein a ratio of the MPTS added and the second quantity of TEOS is between 1:50 and 1:5.

11. The process of claim 1, wherein removing the silica nanoparticles from the mixture comprises centrifugation and washing with ethanol.

12. The process of claim 11, wherein the silica nanoparticles removed from the mixture are washed with ethanol at least three times.

13. The process of claim 1, wherein drying the silica nanoparticles comprises air drying.

14. The process of claim 13, wherein air drying takes place over at least two days.

15. The process of claim 1, further comprising:
grinding the dried silica nanoparticles into a powder.

16. The process of claim 1, wherein the organic solvent, surfactant, water, first quantity of the first silica precursor, ammonia, second quantity of the first silica precursor, second silica precursor and acetone are added at a ratio of approximately 7500:3570:480:50:18:50:50:20000.

17. Silica nanoparticles prepared by the method of claim 1.

18. A method for preparing nanoparticles, the method comprising:
preparing a mixture of cyclohexane, Triton™ X-100, 1-hexanol, and water;
adding a first quantity of TEOS and ammonia to the mixture;
stirring the mixture for approximately one day after adding the TEOS and ammonia;
adding a second quantity of TEOS and APTS to the mixture;
stirring the mixture for approximately one day after adding the TEOS and APTS;
adding acetone to the mixture;
removing silica nanoparticles from the mixture by centrifugation and washing with ethanol; and
drying the silica nanoparticles in air for approximately two days.

19. A method for producing nanoparticles having a silica shell with a rough surface, the method comprising:
preparing a mixture containing nanoparticle cores;
forming a shell around the nanoparticle cores by adding a first silica precursor and a second silica precursor to the mixture;
removing nanoparticles having a silica shell from the mixture; and
drying the nanoparticles so that the silica shell has a rough surface.

20. The method of claim 19, wherein the first silica precursor is TEOS and the second silica precursor is APTS.
